(19) United States
(12) Patent Application Publication
(10) Pub. No.: US 2015/0086829 A1
(43) Pub. Date: Mar. 26, 2015

(54) BATTERY MODULE HAVING THERMALLY CONDUCTIVE HOLDING FRAME

(71) Applicant: UER TECHNOLOGY CORPORATION, Miaoli County (TW)

(72) Inventors: RAY-TANG SUN, Miaoli (TW); TSUNG-HSIEN CHUANG, Miaoli (TW); CHIEN-LUNG CHEN, Miaoli (TW)

(73) Assignee: UER TECHNOLOGY CORPORATION, Miaoli County (TW)

(21) Appl. No.: 14/067,992

(22) Filed: Oct. 31, 2013

(30) Foreign Application Priority Data
Sep. 25, 2013 (TW) 102134519

(51) Int. Cl. H01M 10/6554

(52) U.S. Cl. CPC H01M 10/5053
USPC 429/120

(57) ABSTRACT

A battery module includes a top holding frame, a bottom holding frame, and a number of batteries. The top holding frame is made of thermally conductive plastic. The top holding frame defines a number of top receiving holes. The bottom holding frame is connected to and spaced from the top holding frame. The bottom holding frame defines a number of bottom receiving holes aligned with the top receiving holes one by one. Each of batteries includes a shell, an anode and a cathode at opposite sides of the shell. The batteries are positioned between the top holding frame and the bottom holding frame with the anodes of the batteries engaged in the respective top receiving holes and the cathodes of the batteries engaged in the respective bottom receiving holes.

### CROSS REFERENCE

This application claims the benefit of co-pending U.S. Application US 53929 filed by the applicant or assignee of the present invention simultaneously with the present application, which is hereby incorporated herein. The co-pending application is temporarily identified by its Attorney docket number. This will be replaced by the corresponding USSN when available.

### BACKGROUND

1. Technical Field

The present disclosure relates to a battery module.

2. Description of Related Art

A battery module having a number of batteries is widely used in electronic equipment (eg, electric vehicles) as a power source. As there are many batteries in a single battery module, heat is built up in the battery module during operation and will make the battery module not work normally and safe.

Therefore, it is desirable to provide a battery module, to overcome or at least alleviate the above-mentioned problems.

### BRIEF DESCRIPTION OF THE DRAWINGS

FIG. 1 is a schematic, isometric view of a battery module, according to a first exemplary embodiment.

FIG. 2 is a partial exploded view of the battery module of FIG. 1.

FIG. 3 is similar to FIG. 2, but viewed from another angle.

FIG. 4 is a schematic, isometric view of the battery module of FIG. 1 with a heat dissipating plate, top electric conductive pieces, a first and a second top electric conductive strips, bottom electric conductive pieces, a first and a second bottom electric conductive strips removed.

FIG. 5 is a schematic, isometric view of the battery module of FIG. 4 with batteries removed.

FIG. 6 is an exploded view of the battery module of FIG. 5.

FIG. 7 is an exploded view of a top holding frame of the battery module of FIG. 5.

FIG. 8 is an exploded view of a bottom holding frame of the battery module of FIG. 5.

FIG. 9 is a schematic, isometric view of a first supporting plate of the battery module of FIG. 5.

FIG. 10 is a schematic, isometric view of a second supporting plate of the battery module of

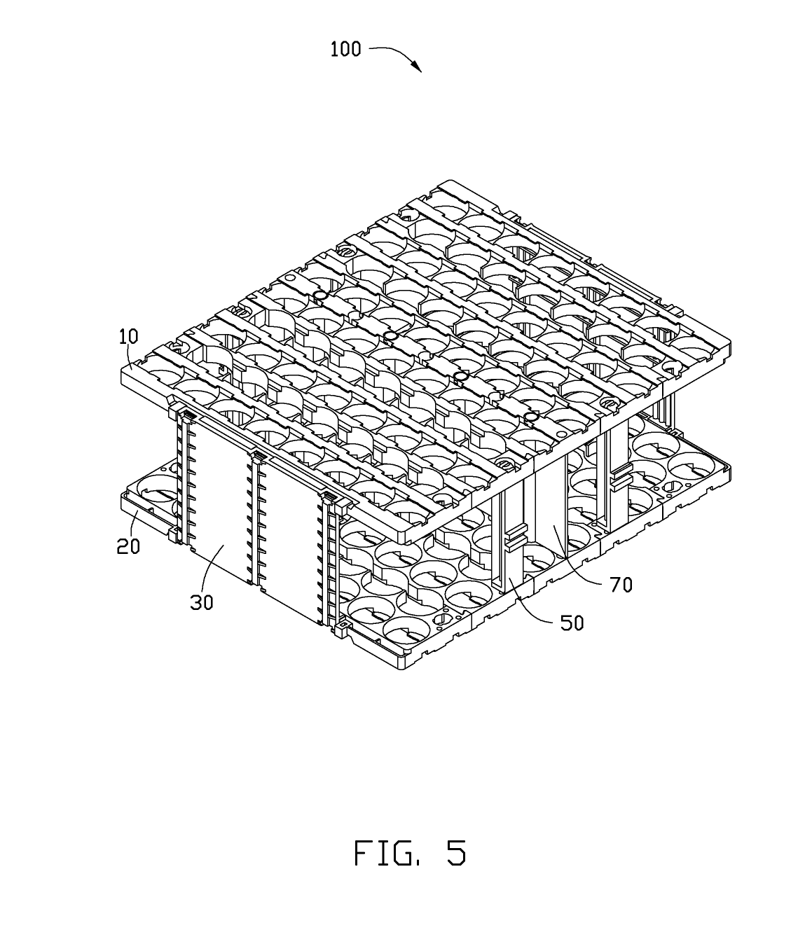

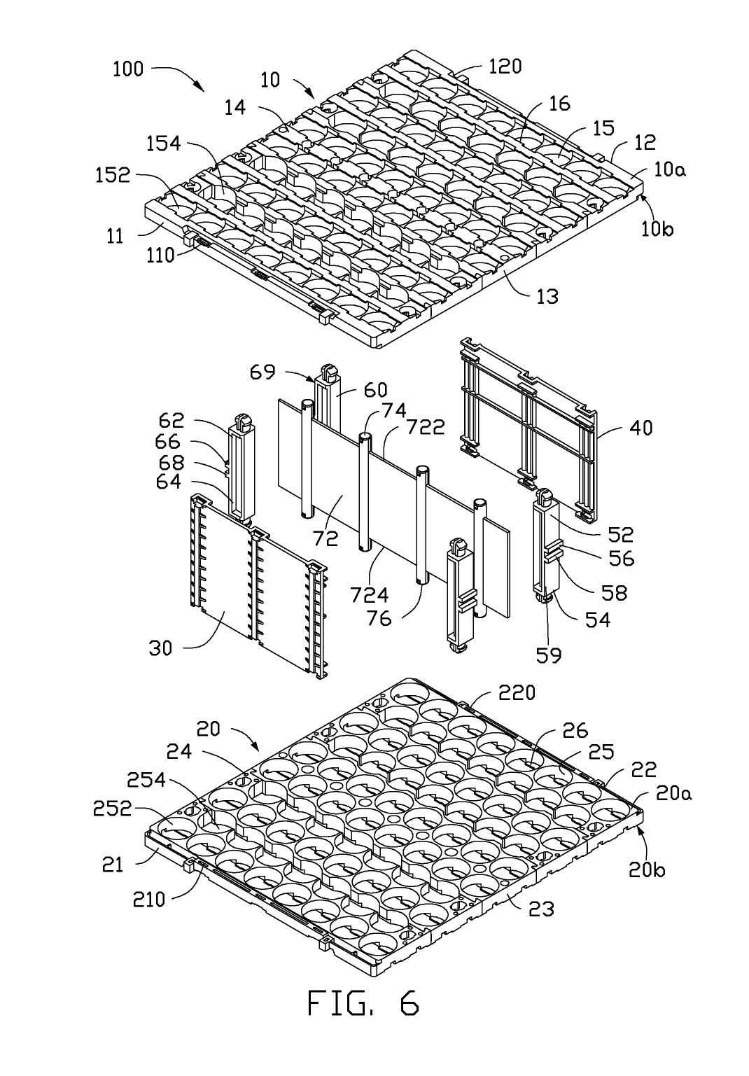

FIG. 5.

FIG. 11 is a partial exploded view of a battery module, according to a second exemplary embodiment.

### DETAILED DESCRIPTION

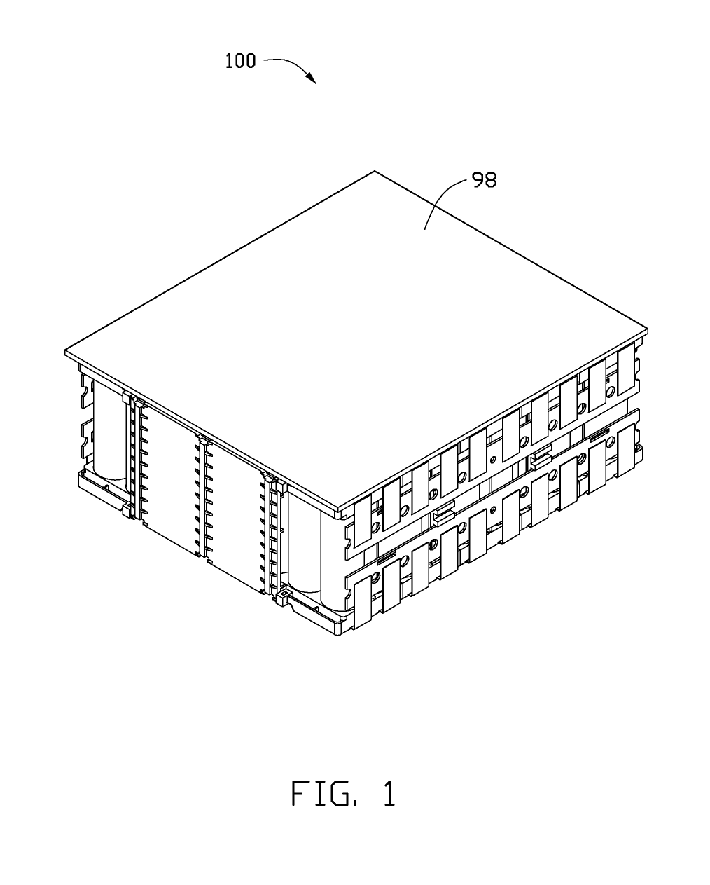

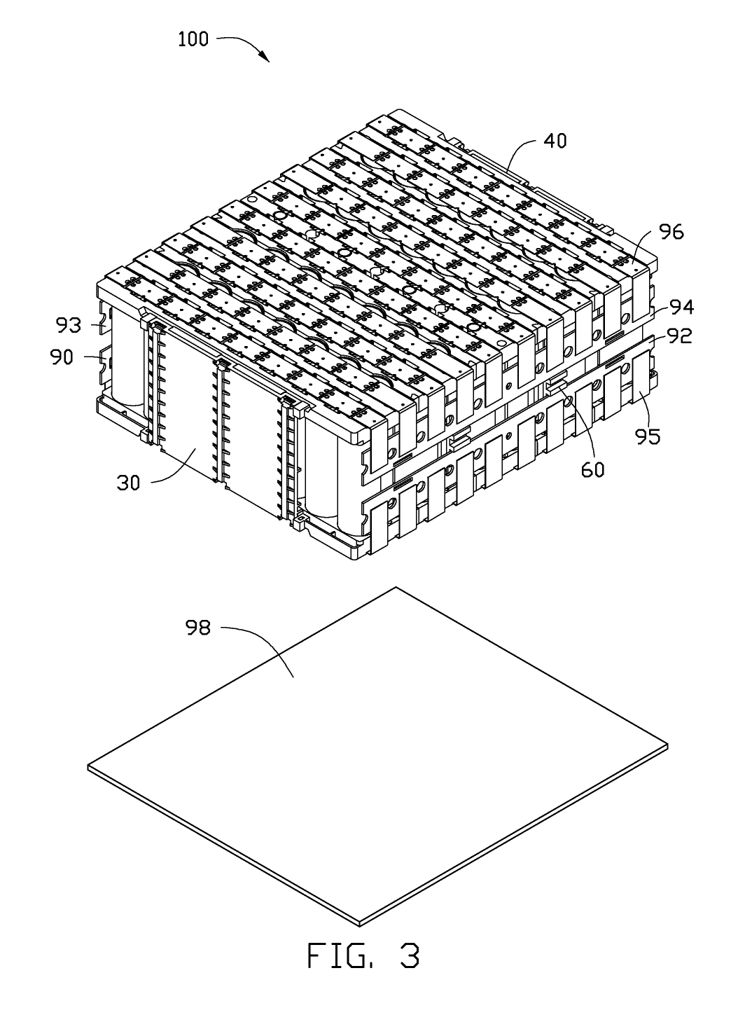

FIGS. 1-4 show a battery module 100 according to a first exemplary embodiment. The battery module 100 includes a top holding frame 10, a bottom holding frame 20, a first supporting plate 30, a second supporting plate 40, two first supporting rods 50, two second supporting rods 60, a reinforcing plate 70, a number of batteries 80, a first top electric conductive strip 90, a second top electric conductive strip 92, a first bottom electric conductive strip 93, a second bottom electric conductive strip 94, a number of top electric conductive pieces 95, a number of bottom conductive pieces 96, and a heat dissipating plate 98.

Also referring to FIGS. 5-7, the top holding frame 10 is substantially rectangular and is made of thermally conductive plastic. The top holding frame 10 is electrically nonconductive and elastic. The top holding frame 10 includes a first sidewall 11, a second sidewall 12, a third sidewall 13 and a fourth sidewall 14. The first sidewall 11 is opposite and parallel to the second sidewall 12. The third sidewall 13 is opposite and parallel to the fourth sidewall 14. The first sidewall 11 and the second sidewall 12 are perpendicular to the third sidewall 13 and the fourth sidewall 14. The first sidewall 11, the second sidewall 12, the third sidewall 13, and the fourth sidewall 14 are connected end to end in sequence. The first sidewall 11 defines three first top clamping holes 110. The three first top clamping holes 110 are arranged in a line along a direction from the fourth sidewall 14 to the third sidewall 13. The second sidewall 12 defines three second top clamping holes 120. The three second top clamping holes 120 are arranged in a line along a direction from the fourth sidewall 14 to the third sidewall 13.

The top holding frame 10 further includes a upper surface 10a and a lower surface 10b. The upper surface 10a is opposite and parallel to the lower surface 10b. The top holding frame 10 defines a number of top receiving holes 15 extending through the upper surface 10a and the lower surface 10b. The top receiving holes 15 are assigned into a number of first top receiving hole groups 152 and a number of second top receiving hole groups 154. Each first top receiving hole group 152 includes a number of top receiving holes 15 arranged in a line along a direction from the third sidewall 13 to the fourth sidewall 14. Each second top receiving hole group 154 includes a number of top receiving holes 15 arranged in a line along a direction from the third sidewall 13 to the fourth sidewall 14. The top receiving holes 15 of the first top receiving hole groups 152 are misaligned with relative to the top receiving holes 15 of the second top receiving hole groups 154. A number of buffering boards 16 corresponding to the top receiving holes 15 one by one are formed on the upper surface 10a. Each buffering board 16 extends into the corresponding top receiving hole 15 and partly covers the top receiving hole 15. In this embodiment, there are six first top receiving hole groups 152 and four second top receiving hole groups 154. Each first top receiving hole group 152 includes eight top receiving holes 15. Each second top receiving hole group 154 includes seven top receiving holes 15. The line along which the top receiving holes 15 of the first top receiving hole group 152 are arranged is parallel to the line along which the top receiving holes 15 of the second top receiving hole group 154 are arranged.

In this embodiment, the top holding frame 10 is detachable, and includes a middle part 17, two connecting parts 18 and two end parts 19. The two connecting parts 18 are detachably mounted on opposite sides of the middle part 17. The two connecting parts 18 and the middle part 17 are arranged between the two end parts 19. The two end parts 19 are respectively detachably mounted on the two connecting parts 18.

In detail, the middle part 17 includes a first side surface 172 and an opposite second side surface 174. The middle part 17 defines two first top receiving hole groups 152, four fixing holes 176, fourteen first notches 177 and four clamping grooves 178. The two top receiving hole groups 152 are located between the first side surface 172 and the second side surface 174. The four fixing holes 176 are located between the two top receiving hole groups 152. The four fixing holes 176 are arranged along a line from the third sidewall 13 to the fourth sidewall 14. The fourteen first notches 177 are evenly formed at the first side surface 172 and the second side surface 174. The four clamping grooves 178 are located at the four corners of the middle part 17. The middle part 17 further includes four limiting hooks 179 corresponding to the four clamping grooves 178. Each limiting hook 179 extends into the corresponding clamping groove 178.

Each connecting part 18 includes a third side surface 182 and an opposite fourth side surface 184, and defines one first top receiving hole group 152, seven first notches 177, seven second notches 186 and two clamping grooves 178. The first top receiving hole group 152 is located between the third side surface 182 and the fourth side surface 184. The seven first notches 177 are defined at the fourth side surface 184. The seven second notches 186 are defined at the third side surface 182. The two clamping grooves 178 are located at two opposite ends of the fourth side surface 184. Each connecting part 18 further includes two limiting hooks 179 corresponding to the two clamping grooves 178 and two clamping hooks 188 corresponding to the two limiting hooks 179. Each limiting hook 179 extends into the corresponding clamping groove 178. The two clamping hooks 188 extend outwardly from two ends of the third side surface 182.

Each end part 19 includes a fifth side surface 192 and an opposite sixth side surface 194. One sixth side surface 194 of one end part 19 is an outer surface of the first sidewall 11. One sixth side surface 194 of the other end part 19 is an outer surface of the second sidewall 12. The end part 19 includes one first top receiving hole group 152 and seven second notches 186. The first top receiving hole group 152 is located between the fifth side surface 192 and the sixth side surface 194. The seven second notches 186 are defined at the fifth side surface 192. Each end part 19 further includes two clamping hooks 188. The two clamping hooks 188 extend outwardly from two ends of the fifth side surface 192.

When assembling, first, the clamping hooks 188 at the third side surface 182 are received in the clamping grooves 178 of the middle part 17 and engage with the corresponding limiting hooks 179 to mount the two connecting parts 18 on the first side surface 172 and the second side surface 174 of the middle part 17. Then the clamping hooks 188 at the fifth side surface 192 are received in the clamping grooves 178 at the fourth side surface 184 and engage with the corresponding limiting hooks 179 to mount the two end parts 19 on the fourth side surface 184 of the two connecting parts 18. At this time, each second notch 186 in the connecting part 18 and the corresponding first notch 177 in the middle part 17 are aligned with each other and cooperatively form a top receiving hole 15 of the second top receiving hole group 154, and each first notch 177 in the connecting part 18 and the corresponding second notch 186 in the end part 19 are aligned with each other and cooperatively form a top receiving hole 15 of the second top receiving hole group 154. Because the top holding frame 10 is elastic, the clamping hooks 188 can be elastically deformed to disengage with the limiting hooks 179 to disassemble the middle part 17, the two connecting parts 18 and the two end parts 19.

In addition, the thermally conductive plastic for forming the top holding frame 10 includes a plastic material and thermally conductive material scattered in the plastic material. The plastic material is a common plastic, such as Polyamide and Polycarbonate. The thermally conductive material is evenly scattered in the plastic material to form a thermal conductive network. The thermally conductive material can be carbon, such as graphite fibers or carbon fibers, or can be particles of metallic oxide. In this embodiment, the plastic material is Polyamide, the thermally conductive material is carbon fibers. The weight ratio of the plastic material to the thermally conductive material is 50%˜70%:30%˜50%, and a sum of the weight of the plastic material and the thermally conductive material does not exceed the weight of the thermally conductive plastic. When the thermally conductive material or the weight ratio of the plastic material to the thermally conductive material varies, the thermal conductivity coefficient of the thermally conductive plastic varies accordingly. In this embodiment, the thermal conductivity coefficient of the thermally conductive plastic 300 exceeds 3 w/mk (watt/(meter*kelvin)).

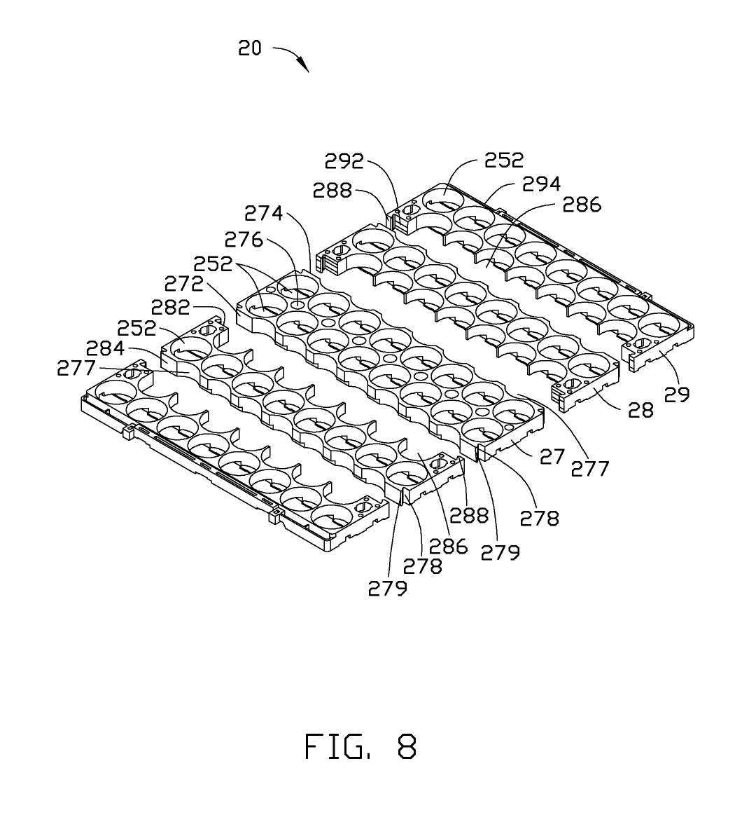

Referring to FIGS. 5-6, and 8, the structure of the bottom holding frame 20 is substantially the same as that of the top holding frame 10. The bottom holding frame 20 is substantially rectangular and is elastic. The bottom holding frame 20 includes a first outer wall 21, a second outer wall 22, a third outer wall 23 and a fourth outer wall 24. The first outer wall 21 is opposite and parallel to the second outer wall 22. The third outer wall 23 is opposite and parallel to the fourth outer wall 24. The first outer wall 21 and the second outer wall 22 are perpendicular to the third outer wall 23 and the fourth outer wall 24. The first outer wall 21, the second outer wall 22, the third outer wall 23, and the fourth outer wall 24 are connected end to end in sequence. The first outer wall 21 defines three first bottom clamping holes 210. The three first bottom clamping holes 210 are arranged in a line along a direction from the fourth outer wall 24 to the third outer wall 23. The second outer wall 22 defines three second bottom clamping holes 220. The three second bottom clamping holes 220 are arranged in a line along a direction from the fourth outer wall 24 to the third outer wall 23.

The bottom holding frame 20 further includes a top surface 20a and a bottom surface 20b. The top surface 20a is opposite and parallel to the bottom surface 20b. The bottom holding frame 20 defines a number of bottom receiving holes 25 extending through the top surface 20a and the bottom surface 20b. The bottom receiving holes 25 are assigned to a number of first bottom receiving hole groups 252 and a number of second bottom receiving hole groups 254. Each first bottom receiving hole group 252 includes a number of bottom receiving holes 25 arranged in a line along a direction from the third outer wall 23 to the fourth outer wall 24. Each second bottom receiving hole group 254 includes a number of bottom receiving holes 25 arranged in a line along a direction from the third outer wall 23 to the fourth outer wall 24. The bottom receiving holes 25 of the first bottom receiving hole group 252 are misaligned with relative to the bottom receiving holes 25 of the second bottom receiving hole group 254. A number of supporting boards 26 corresponding to the bottom receiving holes 25 one by one are formed on the bottom surface 20b. Each supporting board 26 extends into the corresponding bottom receiving hole 25 and partly covers the bottom receiving hole 25. In this embodiment, there are six first bottom receiving hole groups 252 and four second bottom receiving hole groups 254. Each first bottom receiving hole group 252 includes eight bottom receiving holes 25. Each second bottom receiving hole group 254 includes seven bottom receiving holes 25. The line along which the bottom receiving holes 25 of the first bottom receiving hole group 252 are arranged is parallel to the line along which the bottom receiving holes 25 of the second bottom receiving hole group 254 are arranged.

In this embodiment, the bottom holding frame 20 is detachable, and includes a middle portion 27, two connecting portions 28 and two end portions 29. The two connecting portions 28 are detachably mounted on two opposite sides of the middle portion 27. The two connecting portions 28 and the middle portion 27 are arranged between the two end portions 29. The two end portions 29 are respectively detachably mounted on the connecting portions 28.

In detail, the middle portion 27 includes a first outer surface 272 and an opposite second outer surface 274. The middle portion 27 defines two first bottom receiving hole groups 252, four mounting holes 276, fourteen first cutouts 277 and four engagement grooves 278. The two bottom receiving hole groups 252 are located between the first outer surface 272 and the second outer surface 274. The four mounting holes 276 are located between the two bottom receiving hole groups 252. The four mounting holes 276 are arranged along a line from the third outer wall 23 to the fourth outer wall 24. The fourteen first cutouts 277 are evenly formed at the first outer surface 272 and the second outer surface 274. The four engagement grooves 278 are located at the four corners of the middle portion 27. The middle portion 27 further includes four restricting hooks 279 corresponding to the four engagement grooves 278. Each restricting hook 279 extends into the corresponding groove 278.

Each connecting portion 28 includes a third outer surface 282 and an opposite fourth outer surface 284, and defines one first bottom receiving hole group 252, seven first cutouts 277, seven second cutouts 286 and two engagement grooves 278. The first bottom receiving hole group 252 is located between the third outer surface 282 and the fourth outer surface 284. The seven first cutouts 277 are defined at the fourth outer surface 284. The seven second cutouts 286 are defined at the third outer surface 282. The two engagement grooves 278 are located at two opposite ends of the fourth outer surface 284. Each connecting portion 28 further includes two restricting hooks 279 corresponding to the two engagement grooves 278 and two engagement hooks 288 corresponding to the two restricting hooks 279. Each restricting hook 279 extends into the corresponding engagement groove 278. The two engagement hooks 288 extend outwardly from two ends of the third outer surface 282.

Each end portion 29 includes a fifth outer surface 292 and an opposite sixth outer surface 294. The sixth outer surface 294 is an outer surface of the first outer wall 21 or the second outer wall 22. The end portion 29 includes one first bottom receiving hole group 252 and seven second cutouts 286. The first bottom receiving hole group 252 is located between the fifth outer surface 292 and the sixth outer surface 294. The seven second cutouts 286 are defined at the fifth outer surface 292. Each end portion 29 further includes two engagement hooks 288. The two engagement hooks 288 extend outwardly from two ends of the fifth outer surface 292.

When assembling, first, the engagement hooks 288 at the third outer surface 282 are received in the engagement grooves 278 of the middle portion 27 and engage with the corresponding restricting hooks 279 to mount the two connecting portions 28 on the first outer surface 272 and the second outer surface 274 of the middle portion 27. Then the engagement hooks 288 at the fifth outer surface 292 are received in the engagement grooves 278 at the fourth outer surface 284 and engage with the corresponding restricting hooks 279 to mount the two end portions 29 on the fourth outer surface 284 of the two connecting portions 28. At this time, each second cutout 286 in the connecting portion 28 and the corresponding first cutout 277 in the middle portion 27 are aligned with each other and cooperatively form a bottom receiving hole 25 of the second bottom receiving hole group 254, and each first cutout 277 in the connecting portion 28 and the corresponding second cutout 286 in the end portion 29 are aligned with each other and cooperatively form a bottom receiving hole 25 of the second bottom receiving hole group 254. Because the bottom holding frame 20 is elastic, the engagement hooks 288 can be elastically deformed to disengage with the restricting hooks 279 to disassemble the middle portion 27, the two connecting portions 28 and the two end portions 29.

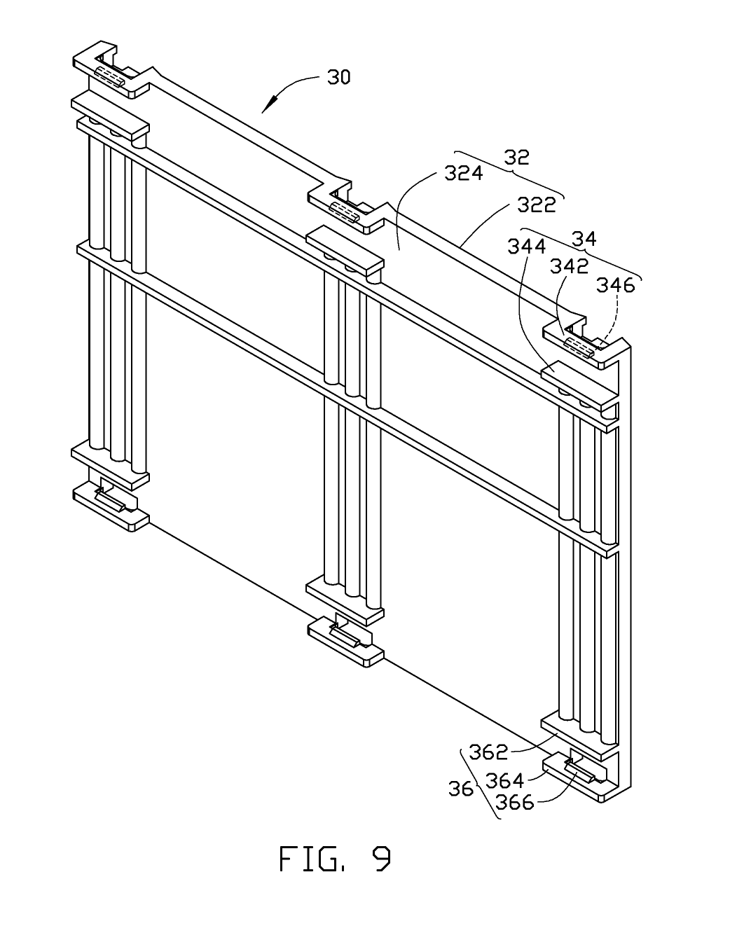

Referring to FIGS. 5-6, and 9, the first supporting plate 30 includes a first main body 32, three first top clamping portions 34 and three first bottom clamping portions 36. The first main body 32 is substantially a rectangular flat plate, and includes a first surface 322 and an opposite second surface 324. The first top clamping portions 34 and the first bottom portions 36 are formed on the second surface 324. The three first top clamping portions 34 are arranged along a line at the top end of the first main body 32 and correspond to the three first top clamping holes 110 one by one. The three first bottom clamping portions 36 are arranged along a line at the bottom end of the first main body 32 and correspond to the three first bottom clamping holes 210 one by one. Each first top clamping portion 34 includes a first top limiting block 342, a second top limiting block 344 spaced from the first top limiting block 342, and a first protrusion 346 protruding from the first top limiting block 342 toward the second top limiting block 344. Each first bottom clamping portion 36 includes a first bottom limiting block 362, a second bottom limiting block 364 spaced from the first bottom limiting block 362, and a second protrusion 366 protruding from the second bottom limiting block 364 toward the first bottom limiting block 362.

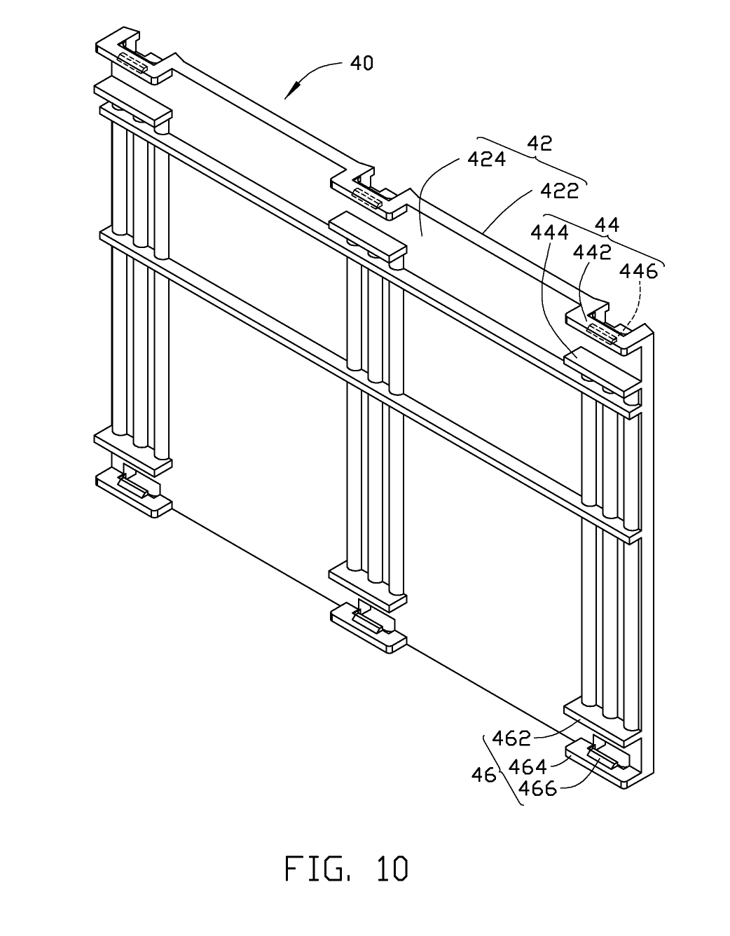

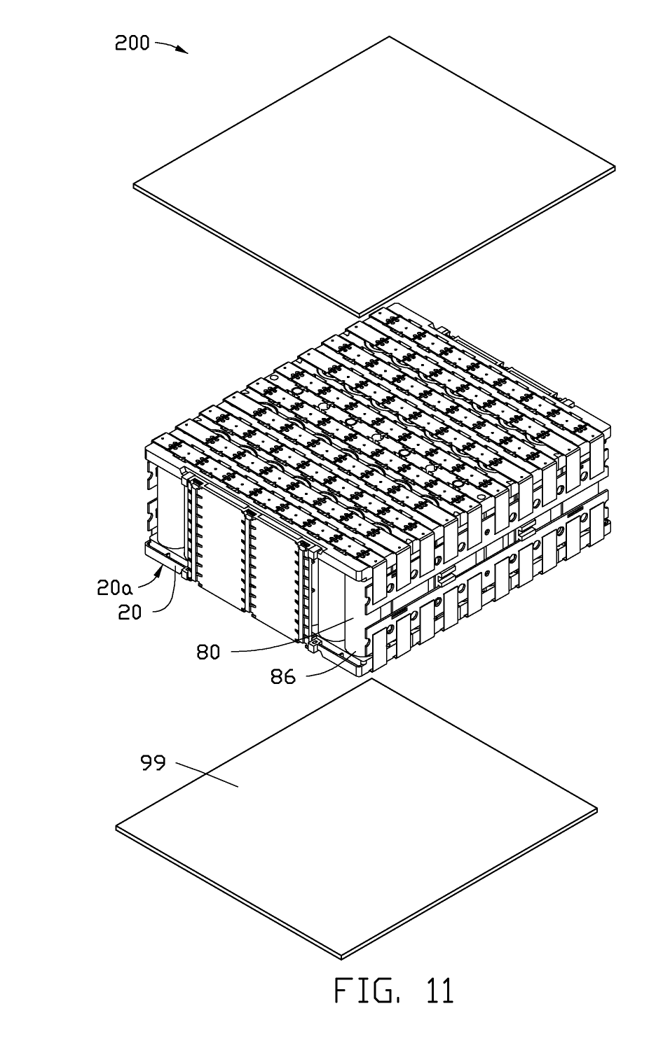

Referring to FIGS. 5-6, and 10, the structure of the second supporting plate 40 is substantially the same as that of the first supporting plate 30. The second supporting plate 40 includes a second main body 42, three second top clamping portions 44 and second bottom clamping portions 46. The second main body 42 is substantially a rectangular flat plate, and includes a first surface 422 and an opposite second surface 424. The second top clamping portions 44 and the second bottom clamping portions 46 are formed on the second surface 424. The three second top clamping portions 44 are arranged along a line at the top end of the second main body 42 and correspond to the three second top clamping holes 210 one by one. The three second bottom clamping portions 46 are arranged along a line at the bottom end of the second main body 42 and correspond to the three second bottom clamping holes 220 one by one. Each second top clamping portion 44 includes a first top restricting block 442, a second top restricting block 444 spaced from the first top restricting block 442, and a first projection 446 protruding from the first top restricting block 442 toward the second top restricting block 444. Each second bottom clamping portion 46 includes a first bottom restricting block 462, a second bottom restricting block 462 spaced from the first bottom restricting block 462, and a second projection 466 protruding from the second bottom restricting block 462 toward the first bottom restricting block 462.

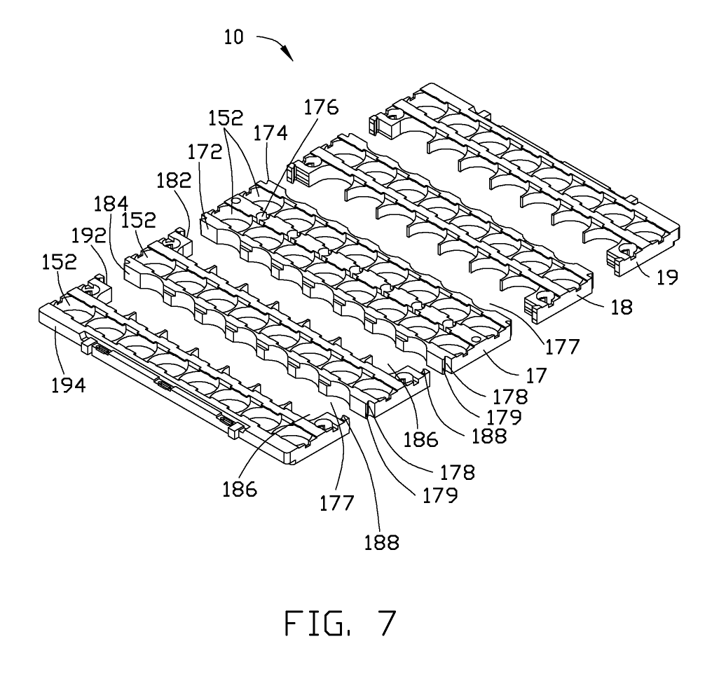

Referring to FIG. 6, each first supporting rod 50 includes a first top end 52, a first bottom end 54, a first limiting piece 56, a second limiting piece 58, and a first outer side surface 59. The first limiting piece 56 protrudes from the first outer side surface 59 at the first top end 52. The second limiting piece 58 protrudes from the first outer side surface 59 at the first bottom end 54.

The structure of the second supporting rod 60 is substantially the same as that of the first supporting rod 50. Each second supporting rod 60 includes a second top end 62, a second bottom end 64, a third limiting piece 66, a fourth limiting piece 68, and a second outer side surface 69. The third limiting piece 66 protrudes from the second outer side surface 69 at the second top end 62. The fourth limiting piece 68 protrudes from the second outer side surface 69 at the second bottom end 64.

The reinforcing plate 70 includes a body 72, four top fixing rods 74, and four bottom fixing rods 76. The body 72 includes a top end 722 and an opposite bottom end 724. The four top fixing rods 74 extend perpendicularly from the top end 722 and correspond to the four fixing holes 176. The four bottom fixing rods 76 extend perpendicularly from the bottom end 724 and correspond to the four mounting holes 276.

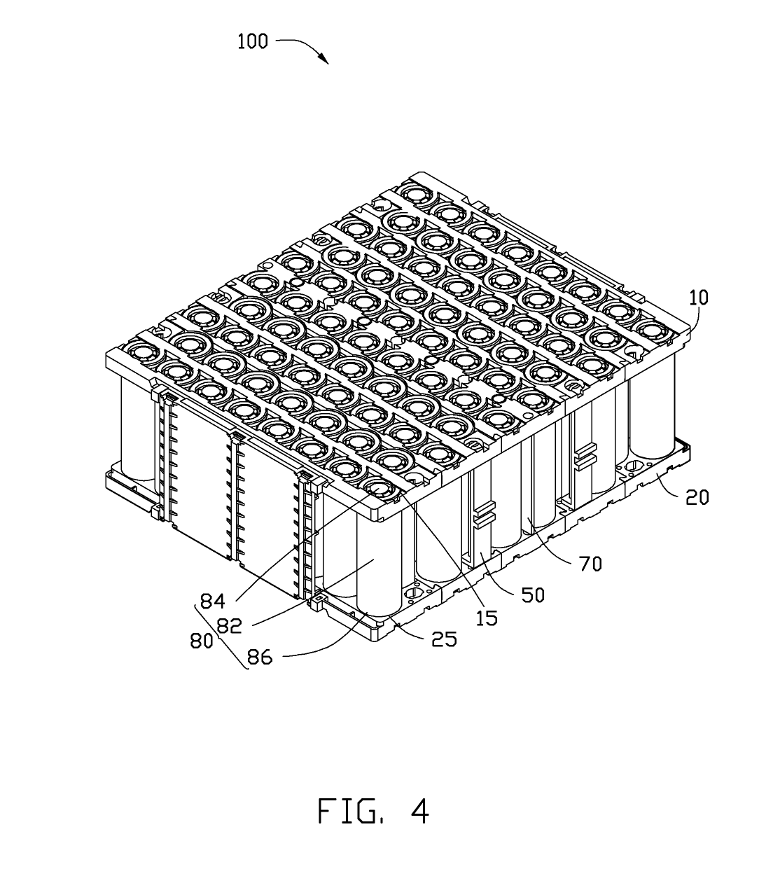

Referring to FIG. 4, each battery 80 includes a shell 82, an anode 84, and a cathode 86. The anode 84 and the cathode 86 are positioned at opposite ends of the shell 82.

Referring to FIGS. 4-6, when loading the batteries 80, first, the top holding frame 10 and the bottom holding frame 20 are respectively integrally assembled according to the method mentioned above. Second, the cathodes 86 of the batteries 80 are inserted into the bottom receiving holes 25 and are supported by the supporting boards 26. The first bottom ends 54 of the two first supporting rods 50 are fixedly inserted into holes (not labeled) defined in the third outer wall 23. The first bottom ends 64 of the two second supporting rods 60 are fixedly inserted into holes (not labeled) defined in the fourth outer wall 24. The four bottom fixing rods 76 are fixedly inserted into the four mounting holes 276. The first and second outer side surfaces 59, 69 face outwardly and are opposite to the batteries 80. Third, the top holding frame 10 is moved to above the bottom holding frame 20. The anodes 84 of the batteries 80 are received in the top receiving holes 15 and are limited by the buffering boards 16. The first top ends 52 of the two first supporting rods 50 are fixedly inserted into holes (not labeled) defined in the third sidewall 13. The first top ends 62 of the two second supporting rods 60 are fixedly inserted into holes (not labeled) defined in the fourth sidewall 14. The four top fixing rods 74 are fixedly inserted into the four fixing holes 176. The top receiving holes 15 are aligned with the bottom receiving holes 25 one by one. The first sidewall 11 is aligned with the first outer wall 21. The second sidewall 12 is aligned with the second outer wall 22. The third sidewall 13 is aligned with the third outer wall 23. The fourth sidewall 14 is aligned with the fourth outer wall 24. Finally, the first sidewall 11 is clamped by the first top limiting blocks 342 and the second top limiting blocks 344. The first protrusions 346 are engaged in the first top clamping holes 110. The first outer wall 21 is clamped by the first bottom limiting blocks 362 and the second bottom limiting blocks 364. The second protrusions 366 are engaged in the first bottom clamping holes 210. The second sidewall 12 is clamped by the first top restricting blocks 442 and the second top restricting blocks 444. The first projections 446 are engaged in the second top clamping holes 210. The second outer wall 22 is clamped by the first bottom restricting blocks 462 and the second bottom restricting blocks 464. The second projections 466 are engaged in the second bottom clamping holes 220. In this way, the top holding frame 10 and the bottom holding frame 20 are fixedly connected together and are spaced from each other. In other embodiments, the first supporting rods 50, the second supporting rods 60, and the reinforcing plate 70 can be removed, and the top holding frame 10 is connected to the bottom holding frame 20 only by the first supporting plate 30 and the second supporting plate 40.

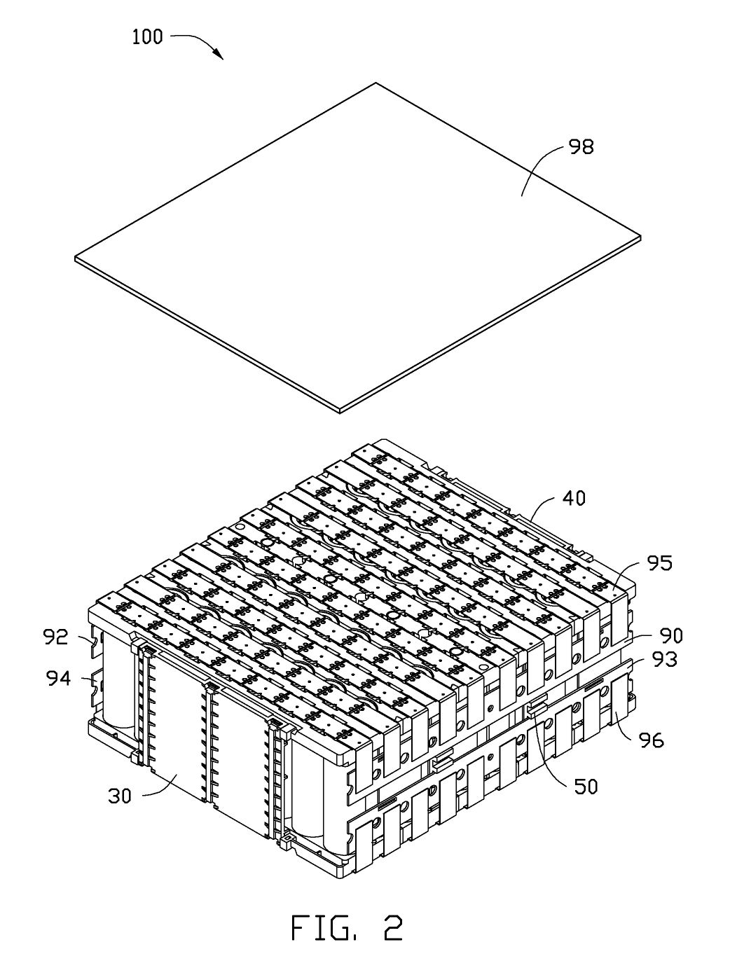

Referring to FIGS. 2 and 5-6, the first top electric conductive strip 90, the second top electric conductive strip 92, the first bottom electric conductive strip 93, the second bottom electric conductive strip 94, the top electric conductive pieces 95, and the bottom electric conductive pieces 96 are made of copper.

The first top electric conductive strip 90 is first supported on the two first limiting pieces 56, and is then adhered to the two first outer side surfaces 59. The first top electric conductive strip 90 is located at the first top end 52. A length of the first top electric conductive strip 90 is substantially equal to that of the third sidewall 13. The second top electric conductive strip 92 is first supported on the two third limiting pieces 66, and is then adhered to the two second outer side surfaces 69. The second top electric conductive strip 92 is located at the second top end 62. A length of the second top electric conductive strip 92 is substantially equal to that of the fourth sidewall 14. The first bottom electric conductive strip 93 first contacts the two second limiting pieces 58, and is then adhered to the two first outer side surfaces 59. The first bottom electric conductive strip 93 is located at the first bottom end 54. A length of the first bottom electric conductive strip 93 is substantially equal to that of the third outer wall 23. The second bottom electric conductive strip 94 first contacts the two second limiting pieces 68, and is then adhered to the two second outer side surfaces 69. The second bottom electric conductive strip 94 is located at the second bottom end 64. A length of the second bottom electric conductive strip 94 is substantially equal to that of the fourth outer wall 24.

The anodes 84 received in the same first top receiving hole group 152 are connected in parallel through the top electric conductive pieces 95. The anodes 84 received in the same second top receiving hole group 154 are connected in parallel through the top electric conductive pieces 95. The anodes 84 adjacent to the third sidewall 13 are connected to the first top electric conductive strip 90 through the top electric conductive pieces 95. The anodes 84 adjacent to the fourth sidewall 14 are connected to the second top electric conductive strip 92 through the top electric conductive pieces 95. The cathodes 86 received in the same first bottom receiving hole group 252 are connected in parallel through the bottom electric conductive pieces 96. The cathodes 86 received in the same second bottom receiving hole group 254 are connected in parallel through the bottom electric conductive pieces 96. The cathodes 86 adjacent to the third outer wall 23 are connected to the first bottom electric conductive strip 93 through the bottom electric conductive pieces 96. The cathodes 86 adjacent to the fourth outer wall 24 are connected to the second bottom electric conductive strip 94 through the bottom electric conductive pieces 96.

Referring to FIGS. 1-2 and 6, the heat dissipating plate 98 is adhered to the upper surface 10a of the top holding frame 10. The heat dissipating plate 98 is made of thermally conductive silicon rubber.

When working, the anodes 84 of the batteries 80 produce heat. As the anodes 84 are received in the top receiving holes 15 and are in contact with the top holding frame 10, and the top holding frame 10 is made of thermally conductive plastic, the top holding frame 10 transfers the heat from the anodes 84 to the heat dissipating plate 98 for heat dissipating, and the heat will not build up in the battery module 100 to make sure the battery module 100 can work normally and safe. As the top holding frame 10 can be used to transfer heat, other heat transferring mechanism can be saved. Thus, the battery module 100 is simplified in structure and small in volume.

Referring to FIG. 11, a battery module 200 according to a second embodiment is shown. The battery module 200 is similar to the battery module 100 except that a bottom holding frame 20 of the battery module 200 is also made of thermally conductive plastic and the battery module 200 further includes a heat dissipating panel 99 adhered to the bottom surface 20b of the bottom holding frame 20. The heat dissipating panel 99 is made of thermally conductive silicon rubber.

In the battery module 200, heat generated from the cathodes 86 can be dissipated by the heat dissipating panel 99. Thus, the heat dissipating efficiency of the battery module 200 is further increased.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A battery module comprising:
a top holding frame made of thermally conductive plastic, the top holding frame defining a plurality of top receiving holes;
a bottom holding frame connected to and being distant from the top holding frame, the bottom holding frame defining a plurality of bottom receiving holes respectively aligned with the top receiving holes; and
a plurality of batteries, each of batteries comprising a shell, an anode and a cathode at opposite sides of the shell, the batteries positioned between the top holding frame and the bottom holding frame with the anodes of the batteries engaged in the respective top receiving holes and the cathodes of the batteries engaged in the respective bottom receiving holes.

2. The battery module of claim 1, further comprising a heat dissipating plate made of thermally conductive silicon rubber and adhered to a surface of the top holding frame facing away from the batteries.

3. The battery module of claim 2, wherein the top holding frame comprises a plurality of buffering boards corresponding to the top receiving holes, the buffering boards formed on the surface of the top holding frame facing away from the batteries, each of the buffering board extends into and partly covers the corresponding top receiving hole, the bottom holding frame comprises a plurality of supporting boards corresponding to the bottom receiving holes, the supporting boards formed on a surface of the bottom holding frame facing away from the batteries, each of the supporting board extends into and partly covers the corresponding bottom receiving hole, and the buffering boards cooperate with the supporting boards to prevent the batteries from sliding out of the top and bottom receiving holes.

4. The battery module of claim 2, wherein the top holding frame comprises a first sidewall and a second sidewall at opposite sides thereof, the bottom holding frame comprises a first outer wall and a second outer wall at opposite sides thereof, the first sidewall corresponds to the first outer wall, the second sidewall corresponds to the second outer wall, the battery module further comprises a first supporting plate and a second supporting plate, a top end of the first supporting plate secured to the first sidewall, a bottom end of the first supporting plate secured to the first outer wall, a top end of the second supporting plate secured to the second sidewall, and a bottom end of the second supporting plate secured to the second outer wall.

5. The battery module of claim 4, wherein the first supporting plate comprises a plurality of first top clamping portions at the top end thereof and a plurality of first bottom clamping portions at the bottom end thereof, each of the first top clamping portions comprises a first top limiting block, a second top limiting block spaced from the first top limiting block, and a first protrusion protruding from the first top limiting block toward the second top limiting block, each of the first bottom clamping portions comprises a first bottom limiting block, a second bottom limiting block spaced from the first bottom limiting block, and a second protrusion protruding from the second bottom limiting block toward the first bottom limiting block, the first sidewall defines a plurality of first top clamping holes, the first outer wall defines a plurality of first bottom clamping holes, the first top limiting blocks cooperate with the second top limiting blocks to clamp the first sidewall, the first protrusions engage in the respective first top clamping holes, the first bottom limiting blocks cooperate with the second bottom limiting blocks to clamp the first outer wall, and the second protrusions engage in the respective first bottom clamping holes.

6. The battery module of claim 5, wherein the second supporting plate comprises a plurality of second top clamping portions at the top end thereof and a plurality of second bottom clamping portions at the top end thereof, each of the second top clamping portions comprises a first top restricting block, a second top restricting block spaced from the first top restricting block, and a first projection protruding from the first top restricting block toward the second top limiting block, each of the second bottom clamping portions comprises a first bottom restricting block, a second bottom restricting block spaced from the first bottom restricting block, and a second projection protruding from the second bottom restricting block toward the first bottom limiting block, the second sidewall defines a plurality of second top clamping holes, the second outer wall defines a plurality of second bottom clamping holes, the first top restricting blocks cooperate with the second top restricting blocks to clamp the second sidewall, the first projections engage in the respective second top clamping holes, the first bottom limiting blocks cooperate with the second bottom limiting blocks to clamp the second outer wall, and the second projections engage in the second bottom clamping holes.

7. The battery module of claim 4, wherein the top holding frame further comprises a third sidewall and a fourth sidewall at another opposite sides thereof, the bottom holding frame further comprises a third outer wall and a fourth outer wall at another opposite sides thereof, the first sidewall corresponds to the third outer wall, the fourth sidewall corresponds to the fourth outer wall, the battery module further comprises two first supporting rods and two second supporting rods, two ends of each of the first supporting rods are respectively fixed on the third sidewall and the third outer wall, and two ends of each of the second supporting rods are respectively fixed on the fourth sidewall and the fourth outer wall.

8. The battery module of claim 7, wherein the top receiving holes comprise a plurality of first top receiving hole groups and a plurality of second top receiving hole groups, each first top receiving hole group comprises some of the top receiving holes arranged in a line along a direction from the third sidewall to the fourth sidewall, each second top receiving hole group comprises some of the top receiving holes arranged in a line along a direction from the third sidewall to the fourth sidewall, and the top receiving holes of the first top receiving hole groups are misaligned with the top receiving holes of the second top receiving hole groups.

9. The battery module of claim 8, wherein the top holding frame comprises a middle part, a plurality of connecting parts, and two end parts, the connecting parts are detachably mounted on opposite sides of the middle part, the two end parts are respectively detachably mounted on two of the connecting parts adjacent to the two end parts, the middle part, each of the connecting parts, and each of the end parts respectively defines one of the first top receiving hole group, the middle part further defines a plurality of first notches, each of the connecting parts further defines a plurality of first notches and a plurality of second notches, each of the end parts further defines a plurality of second notches, each second notch in the connecting part is aligned with one of the first notches in the middle part to form one of the top receiving hole of one of the second top receiving hole groups, each second notch in the end part is aligned with one of the first notches in the connecting part to form one of the top receiving hole of another one of the second top receiving hole groups.

10. The battery module of claim 9, further comprising a plurality of top electric conductive pieces, a first top electric conductive strip, and a second top electric conductive strip, wherein the first top electric conductive strip is mounted on the two first supporting rods, the second top electric conductive strip is mounted on the two second supporting rods, the anodes of the batteries are connected by the top electric conductive pieces, the anodes of the batteries adjacent to the third sidewall are further connected to the first top electric conductive strip by the top electric conductive pieces, and the anodes of the batteries adjacent to the fourth sidewall are further connected to the second top electric conductive strip by the top electric conductive pieces.

11. The battery module of claim 7, wherein the bottom receiving holes comprise a plurality of first bottom receiving hole groups and a plurality of second bottom receiving hole groups, each first bottom receiving hole group comprises some of the bottom receiving holes arranged in a line along a direction from the third outer wall to the fourth outer wall, each second bottom receiving hole group comprises some of the bottom receiving holes arranged in a line along a direction from the third outer wall to the fourth outer wall, and the bottom receiving holes of the first bottom receiving hole groups are misaligned with relative to the bottom receiving holes of the second bottom receiving hole groups.

12. The battery module of claim 11, wherein the bottom holding frame comprises a middle portion, a plurality of connecting portions, and two end portions, the connecting portions are detachably mounted on opposite sides of the middle portion, the two end portions are respectively detachably mounted on two of the connecting portions adjacent to the two end portions, the middle portion, each of the connecting portions, and each of the end portions respectively defines one of the first bottom receiving hole group, the middle portion further defines a plurality of first cutouts, each of the connecting portion further defines a plurality of first cutouts and a plurality of second cutouts, each of the end portions further defines a plurality of second cutouts, each second cutout in the connecting portion is aligned with one of the first cutouts in the middle portion to form one of the bottom receiving hole of one of the second bottom receiving hole groups, and each second cutout in the end portion is aligned with one of the first cutouts in the connecting portion to form one of the bottom receiving hole of another one of the second bottom receiving hole groups.

13. The battery module of claim 12, further comprising a plurality of bottom electric conductive pieces, a first bottom electric conductive strip, and a second bottom electric conductive strip, wherein the first bottom electric conductive strip is mounted on the two first supporting rods, the second bottom electric conductive strip is mounted on the two second supporting rods, the cathodes of the batteries are connected through the bottom electric conductive pieces, the cathodes of the batteries adjacent to the third outer wall are further connected to the first bottom electric conductive strip through the bottom electric conductive pieces, the cathodes of the batteries adjacent to the fourth outer wall are further connected to the second bottom electric conductive strip through the bottom electric conductive pieces.

14. The battery module of claim 2, wherein the bottom holding frame is made of the thermally conductive plastic.

15. The battery module of claim 13, further comprising a reinforcing plate, wherein one end of the reinforcing plate is fixed to the middle part, and the other end of the reinforcing plate is fixed to the middle portion.

16. The battery module of claim 15, further comprising a heat dissipating panel made of thermally conductive silicon rubber and adhered to a surface of the bottom holding frame away from the batteries.
